(19) United States
(12) Patent Application Publication
(10) Pub. No.: US 2002/0002790 A1
(43) Pub. Date: Jan. 10, 2002

(54) Fishing device

(76) Inventor: Daniel V. Foss, Apple Valley, MN (US)

Correspondence Address: Angenehm Law Firm. Ltd., P.O. Box 48755, Coon Rapids, MN, 55448-0755, US

(21) Appl. No.: 09/835,920

(22) Filed: Apr. 16, 2001

Related U.S. Application Data
(63) Continuation-in-part of application No. 09/610,208, filed on Jul. 5, 2000.

(51) Int. Cl. A01K 75/02

(52) U.S. Cl. 43/17.5

(57) ABSTRACT

A fishing device including a hook including an eyelet, a shank and a barbed hook end; an attraction member being at least one member selected from the group consisting of scent and beads; a housing secured to the hook, the housing including an upper inner portion, an upper outer portion, a lower portion and an O-ring, the upper inner portion being threadably securable to the lower portion trapping the O-ring therebetween, the upper inner portion and the lower portion cooperatively defining a cavity and the upper outer portion being selectively fit to the upper inner portion, the upper outer portion containing the attraction member when fit to the upper inner portion; and a light disposed in the cavity.

This application is a continuation in part of application Ser. No. 09/610,208 filed Jul. 5, 2000.

### FIELD OF THE INVENTION

The present invention relates to fishing devices and more particularly to fishing devices having a light, sound and scent attractors.

### BACKGROUND OF THE INVENTION

Fishing lures have been available for a substantial period of time. This technology area continues to evolve as more is learned about the life functions and behaviors of fish. Light has been used to attract fish in dark water, scents, and sound have been used to attract fish. Each of these components may be used in combination to increase the effectiveness.

Light

### SUMMARY OF THE INVENTION

The present invention is a fishing device which may include a hook mechanism, a housing and a lighting mechanism. The hook mechanism may include an eyelet, a shank and a barbed or non-barbed hook end. The hook mechanism may be directly secured to the housing.

The housing preferably includes an upper inner portion, an upper outer portion, a lower portion and an O-ring. The upper inner portion may be threadably securable to the lower portion trapping the o-ring therebetween. When secured, the upper inner

Fish also seek prey through the sense of smell. Various attractants have developed to provide more effective fishing. Many of these attractants come in the form of spray bottles and squirt bottles and are applied to the external surface of the tackle. Water, however, quickly washes these scents away as the tackle is drawn through the water, resulting in the need to constantly apply more. Further, as a result, the release of sent is not constant. Large releases occur immediately on impact of the lure with the water surface and the effectiveness of the scent dissipates upon retrieval. Attractants desirably remain in place and slowly release, during use.

What is needed is a highly visible piece of fishing tackle. Desirably the tackle has a sight, sound, vibration and/or smell component. These components should be readily changeable, as fishing conditions change, without the need to switch tackle.

### SUMMARY OF THE INVENTION

The present invention is a fishing device including a hook, an attractant, a housing and a light. The hook includes an eyelet, a shank and a barbed hook end. The attraction member is preferably a member of the group of scent, beads, mechanism for vibration, and spinners. The light is preferably a battery powered light.

The housing, which is secured to the hook includes an upper inner portion, an upper outer portion, a lower portion and an O-ring. The upper inner portion is threadably securable to the lower portion trapping the O-ring therebetween. The upper inner portion and the lower portion cooperatively define a cavity. The light is disposed in the cavity. The upper outer portion is selectively fit to the upper inner portion. The upper outer portion contains the attraction member when fit to the upper inner portion. The upper outer portion may have a scent release aperture defined therethrough.

The light may reflect off a spinner joined to either the housing or the hook. The spinner may also be designed to create vibration. The light may impact upon, preferably through, dressing joined to the hook. Additionally, or alternatively the light may project through the housing.

Advantageously, this invention combines, into a single compact piece of fishing tackle, scent, vibration, sound attractants and/or light providing more than one manner of attracting fish in case of behavioral changes.

Advantageously, the present invention provides for slow release of scent, giving a uniform release and longevity to the scent.

As a further advantage, this fishing device is arranged such that the light may impact upon moving parts such as a spinner or dressing, adding apparent life to the lure.

As yet another advantage, the present invention allows changing of attractants without removal of the lure.

### DESCRIPTION OF THE FIGURES

FIG. 1 is a cross section of a side view;

FIG. 2 is a perspective view of the cap;

FIG. 3 is a cross section of a second embodiment;

FIG. 4 is a cross-section, showing the spinner joined to the jig;

FIG. 5 is a prospective view showing a second manner of joining the spinner to the jig;

FIG. 6 is a prospective view showing a first spinner;

FIG. 7 is a prospective view showing the second spinner; and

FIG. 8 is a prospective view showing a third spinner.

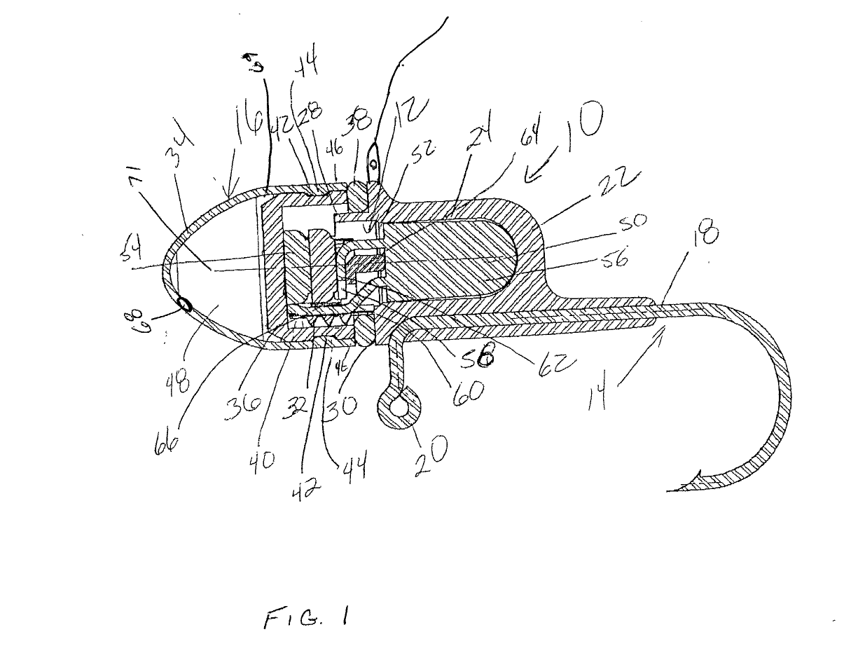

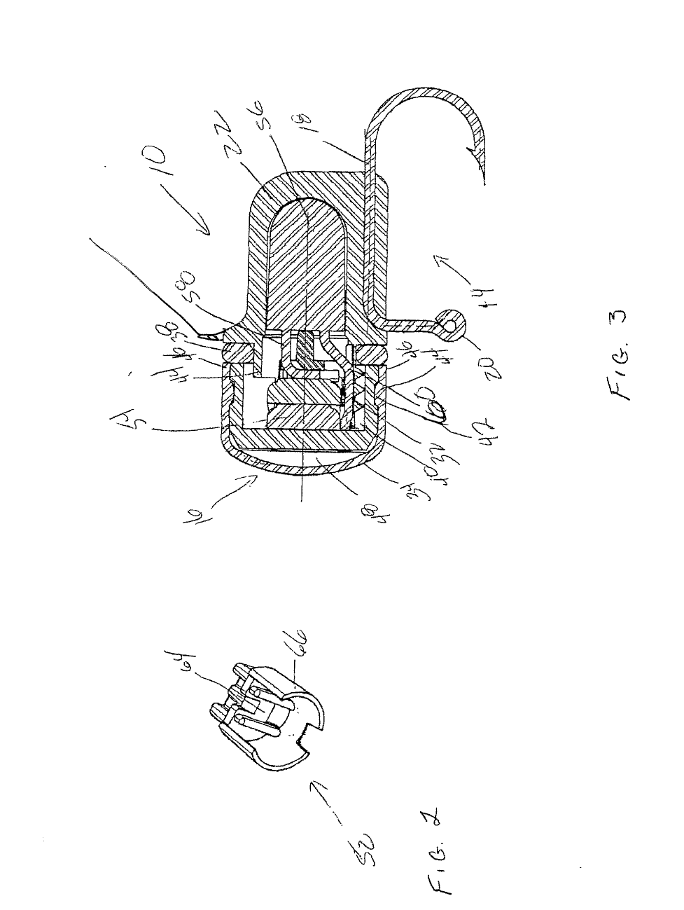

### DETAILED DESCRIPTION OF THE INVENTION

The present invention 10 is a device for fishing. As shown in its preferred embodiment, it is a jig, but may be in a plastic worm, lure, crank bait, spinner, beads or other such piece of fish attracting equipment. The device 10 may come in a wide variety of sizes shapes, appearance, colors and other modifications. The device 10 includes a mechanism 12 for lighting, which attracts fish. Component parts of this unique invention may include a hook mechanism 14, a housing mechanism 16 and the mechanism 12 for lighting. Each of these components will be discussed in serial fashion.

The hook mechanism 14 may be any style hook known in the field of fishing. The hook 14 may be a single, dual, treble or other hook combination. The hook 14 may be manufactured of a broad variety of materials such as those known and used in the field of fishing hooks and polymers of similar strength characteristics and may be tempered. The hook 14 may be barbed or barbless, recognizing that barbless hooks are as effective as barbed hooks, but protect fish from injury so that they may be easily caught and released. The shank 18 may be straight, curved or bent (as shown) and have an eyelet 20 for securing the hook 14 to fishing line.

The housing mechanism 16 protects the lighting mechanism 12 from water damage, while the device 10 is totally submerged. The housing mechanism 16 is a casing including a lower portion 22 an upper outer portion 34, an upper inner portion 36 and a mechanism for sealing 38. Each component will be discussed in serial fashion.

A lower portion 22 may secure to the shank 18 of the hook 14 if the hook is joined to the housing and generally defines a pocket 24. This lower portion 22 is intended to be transparent or translucent, allowing light from the lighting mechanism 12 to pass therethrough, although the lower portion 22 may be opaque if another mechanism for optical communication between the light mechanism 12 and the external world is present such as through the upper housing 36. The lower portion 22 further includes a terminal circumferential wall 28, which is inset to define a shelf 30. The circumferential wall 28 preferably includes threading 32 or other mechanism for attachment.

The upper inner portion 36 may be cap-shaped and have internal threading 40 for engaging the threading 32 of the lower portion 22. The mechanism for sealing 38, preferably a rubber O-ring as shown, may be placed about the circumferential wall 28 of the lower portion 22 adjacent the shelf 30. The upper inner portion 36 may then secure to the lower portion, preferably pinching the mechanism for sealing 38 therebetween. The upper inner portion 36, mechanism for sealing 38 and lower portion 22 provide a water-tight compartment containing the lighting mechanism 12 therein. The upper inner portion 36 may further include external circumferential groove 42 for connection to the upper outer portion 34. While the preferred shapes are as shown, this invention includes other shapes and securement mechanisms that accomplish the same purpose, which is to create a water-tight cavity to hold the lighting mechanism 12. The upper inner portion 36 may be transparent or translucent for optical purposes.

The upper outer portion 34 may be aerodynamically shaped to allow the device 10 to easily move through the water. Alternatively, the upper outer portion 34 may be specifically shaped to cause the device 10 to use water and force on the fishing line to move the device 10 in a life-like manner. The upper outer portion 34 may include a circumferential projection 44 adjacent a lip 46 of the upper outer portion 34. The lip 46 defines an opening extending into a cavity 48, which cavity 48 is further defined by the remainder of the upper outer portion 34. The cavity 48 provides space for the upper inner portion 36, while the circumferential projection 44 provides the male portion of an attachment mechanism sized to be received within the circumferential groove 42.

The lighting mechanism 12 may include a bulb portion 50, a cap portion 52 and a power source 54. The cap portion 52 may have a mechanism for selectively or permanently securing the cap portion 52 from rotation or removal relative to the lower portion 22, such as adhesive, teeth, snap-fit, grooves, shaping, etc. The bulb portion 50 preferably includes a light bulb 56 directly connected to lead wires 58, 60. Lead wire 58 may extend vertically through the cap portion 52 and be bent in an “L” shape with the horizontal portion 62 selectively connectable to the power source. Beneath the lead wire 58 is a contact portion 64 of the cap 52. The contact portion 64 selectively applies pressure to the lead wire 58, pressing it into the power source 54. Lead wire 60 passes through a portion of the cap 52 to an exteneral side 66 thereof. The wire 60 may then come into contact with the power source 54. Either lead wire 58 or 60 may be positive and the other negative depending upon the selection of the manufacturer.

The upper inner portion 36, being threaded may be tightened, pressing the power source 54 and the contact portion 64 together trapping lead 58 therebetween. This tightening completes the circuit, supplying power to the light bulb 56. Loosening the upper inner portion 36 releases the pressure between the power source 54 and the contact portion 64 to interrupt the circuit and thereby turn the light off.

The upper outer portion 34 may define at least one aperture 68 sized to release scent therethrough. The scent may be any commercially available scent. The number of apertures 68 and size may be chosen based upon the desired release rate of scent contained within the upper outer portion 34, which is secured to the upper inner portion 36. The upper outer portion 34 may include a plate 69 positioned to define a attractant cavity 71 in the upper outer portion 34. In this mode, scent may be inserted into the attractant cavity via an elongated hollow member, such as a hypodermic needle, inserted through the aperture 68.

Desirably, the at least one aperture 68 is small enough to retain beads 70 or other such sound attractant within the upper outer portion 34 when the upper outer portion 34 is secured to the upper inner portion 36. The beads 70 should be sufficient in size, number and material to create sound audable to fish when in use. Use of beads 70 is generally to be used in exchange with scent, although use of the beads 70 with scent all secured between the upper outer portion 34 and upper inner portion 36 is within the purview of the present invention. Additionally or alternatively to scent and beads 70 is use of a light, which may be chemically powered, such as chemiluminescence. If the upper outer portion 34 includes plate 69, the beads may be permanently mounted within the cavity 71 and the aperture 68 may not be present.

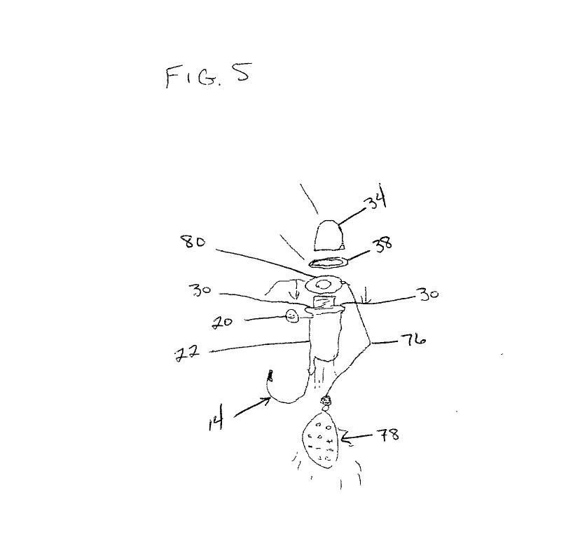

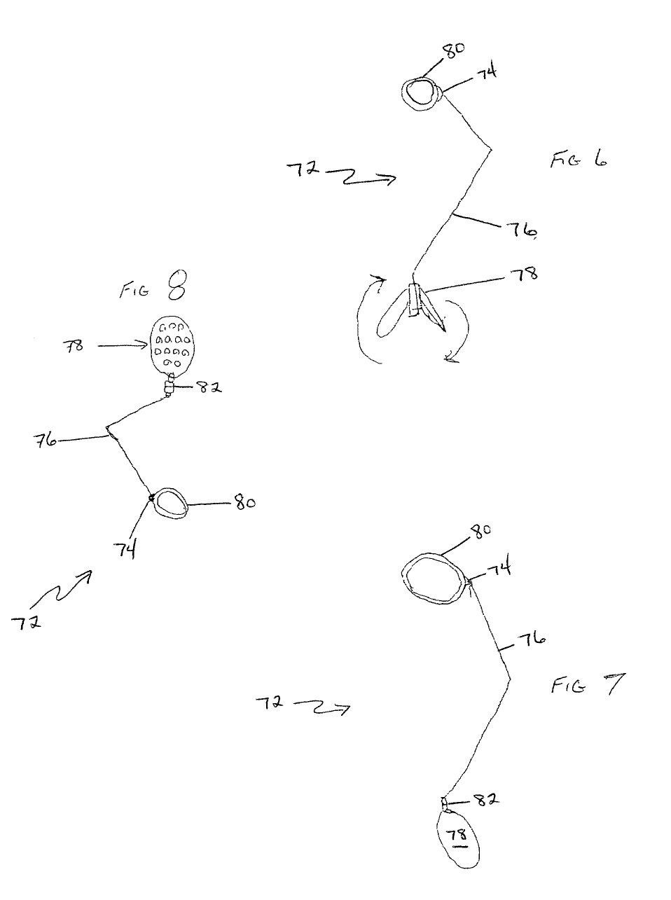

A spinner 72 may be secured to the housing 16 or hook 14. FIG. 5 shows a manner of joining the spinner 72 to the device 10. Spinner 72 includes a ring 74, a lead 76 and a plate 78. The ring 74 defines an aperture sized to fit about a portion of the upper inner portion 36, resting adjacent the O-ring 38. Tightening of the upper outer portion 34 relative to the upper inner portion 36 secures the ring 74 in place. The lead 76 joins the ring 74 to the plate 78 directly or in combination with a swivel 82. The lead 76 is preferably of a length that allows the plate 78 to trail behind the hook 14. The plate 78, generally dish shaped, may be dimpled, as shown in FIG. 7, or smooth, as shown in FIG. 8, and may come in a variety of metal and non-metal colors. Multiple plates 78, as shown in FIG. 6, may be used if desired.

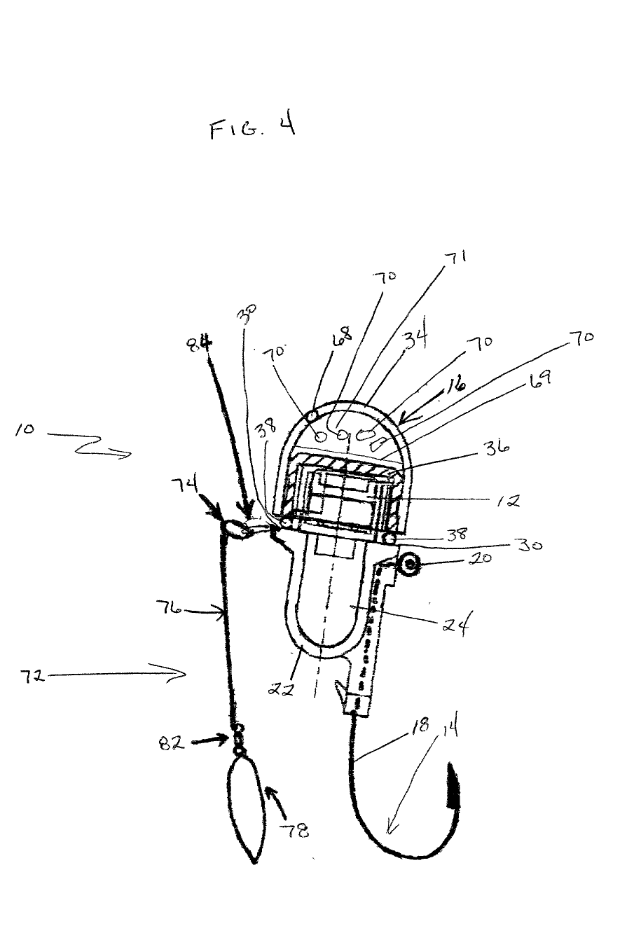

FIG. 4 shows a preferred manner of joining spinner 72 to the device 10. The spinner 72 may be secured to a body attachment ring 84 of the housing 16. The ring 84 of the spinner 72 is releasably interlocked with the ring 84 of the housing 16. The lead 76 extends from the ring 84 to the plate 78. The ring 84 is preferably integral with the housing 16 and formed of the same material. A central axis of the ring 84 should be parallel with the direction of draw through the water and the opening 80 should be sized such that water freely flows therethrough. Desireably the opening 80 should be at least ⅛ inch in diameter and the material forming the ring should have at least a 1/16 inch diameter. Multiple holes 80 may be present much like a series of rings 84 and the ring(s) 84 may circumscribe the housing 16. Making the ring(s) 84 is this manner provides for a wake of water as the device 10 is drawn therethrough. Beyond providing a place for attachment of the spinner 72, distinct advantages result from disturbing the water with this ring structure 84, including, but not limited to, creating vibration for attracting fish and to disbursing of the sound and scent.

The present invention advantageously provides rapid and dramatic altering of the fishing lure without the need to locate new tackle, take unwanted tackle off the line and tie new tackle onto the line. For instance, a spinner 72 can be rapidly connected or removed from the device 10, a light can be turned off or on, sound and/or scent may be added or removed simply with exchange or adjustment of the upper outer portion 34. Colored dressing may be slipped on or off the hook 14 to change coloration and translucency may be used such that the dressing alters the color tone of the light 12. These features provide simple changes that can be made in a matter of seconds to transform a lure fish are not perceiving into a lure fish rapidly take without the hassle required of prior art devices.

Although the present invention has been described with reference to preferred embodiments, workers skilled in the art will recognize changes may be made in form and detail without departing from the spirit and scope of the invention.

I claim:

1. A fishing device comprising:
a hook including an eyelet, a shank and a barbed hook end;
an attraction member being at least one member selected from the group consisting of scent and beads;
a housing secured to the hook, the housing including an upper inner portion, an upper outer portion, a lower portion and an O-ring, the upper inner portion being threadably securable to the lower portion trapping the O-ring therebetween, the upper inner portion and the lower portion cooperatively defining a cavity and the upper outer portion being selectively fit to the upper inner portion, the upper outer portion containing the attraction member when fit to the upper inner portion; and
at least one light disposed in the cavity.

2. A fishing attracting device comprising:
a first attraction member, the attraction member being at least one member selected from the group consisting of light devices, sound devices, and scent;
a second attraction member, the attraction member being at least one member selected from the group consisting of light devices, sound devices, and scent;
a housing defining a cavity, the cavity containing the first attraction member; and
a cap securable to the housing, the cap and the housing containing the second attraction member.

3. The device of claim 2 further including:
a hook joined to the housing, and
a spinner joined to the housing.

4. The device of claim 2 further comprising means for sealing the cavity.

5. The device of claim 3 wherein the means for sealing is an O-ring.

6. The device of claim 2 further comprising a hook joined to the housing.

7. The device of claim 2 further comprising dressing, the dressing allowing light to pass therethough.

8. The device of claim 2 wherein the light is battery powered.

9. The device of claim 2 wherein the cap has a scent release aperture defined therethrough.

10. The device of claim 2 further including a spinner joined to the housing.

11. A fishing attracting device comprising:
a housing defining a water tight cavity;
means for lighting disposed in the cavity, the lighting means including a bulb, and means for powering the bulb, the bulb being powered when the housing is in a compressed state and the bulb losing power when the housing is in a relaxed state; and
a cap, the cap joined to the housing, the cap containing a fish attractant.

12. The device of claim 11 wherein the housing comprises an upper inner portion and a lower portion, the upper inner portion threadably engaging the lower portion.

13. The device of claim 12 further comprising means for sealing the housing.

14. The device of claim 13 Wherein the sealing means is an O-ring disposed between the upper inner portion and the lower portion.

15. The device of claim 12 wherein the housing is in a compressed state when the upper inner portion is tightened to the lower portion and is in a relaxed state when the upper inner portion is loosened relative to the lower portion.

16. The device of claim 11 the housing includes a body attachment ring have a central axis parallel with the direction the device moves through the water, the body attachment ring sized and shaped to create a water wake as the device is drawn through water.

17. The device of claim 11 further comprising first and second leads in power communication with the bulb.

18. The device of claim 11 wherein the fish attractant is selected from the group consisting essentially of: scent and sound devices.

19. The device of claim 11 further including a spinner joined to the housing.

20. The device of claim 11 further including a hook secured to the housing and a spinner joined to the hook.
